(19) United States
(12) Patent Application Publication
(10) Pub. No.: US 2011/0096048 A1
(43) Pub. Date: Apr. 28, 2011

(54) DISPLAY BRIGHTNESS ADJUSTMENT

(76) Inventors: Paul S. Diefenbaugh, Portland, OR (US); Michael C. Walz, Vacouver, WA (US); Philip J. Corriveau, Forest Grove, OR (US)

(21) Appl. No.: 12/980,934

(22) Filed: Dec. 29, 2010

Related U.S. Application Data
(63) Continuation of application No. 12/849,592, filed on Aug. 3, 2010.
Application No. 12/849,592 is a division of application No. 10/981,303, filed on Nov. 4, 2004, now abandoned.

(51) Int. Cl. G09G 5/00

(52) U.S. Cl. 345/207

(57) ABSTRACT

Embodiments of the present invention can receive a data point defining an ambient light level associated with a display and a corresponding brightness adjustment of the display with respect to a reference brightness. The embodiments can then define a brightness response model for the display based on the data point and at least one additional data point.

### RELATED APPLICATION

This application is a continuation of U.S. patent application Ser. No. 12/849,592, entitled “DISPLAY BRIGHTNESS ADJUSTMENT,” filed Aug. 3, 2010 (attorney docket no. P17646D), which is a divisional of U.S. patent application Ser. No. 10/981,303, entitled “DISPLAY BRIGHTNESS ADJUSTMENT,” filed Nov. 4, 2004 (attorney docket no. P17646). U.S. patent application Ser. Nos. 12/849,592 and 10/981,303 are herein incorporated by reference.

### FIELD OF THE INVENTION

The present invention relates to the field of display technology. More specifically, the present invention relates to techniques for adjusting the brightness of a display.

### BACKGROUND

Power consumption is an important consideration in mobile computers because it affects battery life. The brightness level of a display can make a significant difference in the power consumption of a mobile computer, potentially accounting for several hours worth of battery life. For instance, a typical mobile computer may be able to operate on battery power for several hours longer at a lower brightness level than at a maximum brightness level.

Many mobile computer users do not change their display brightness even though it may be brighter than necessary in many environments, and even though they could save power by doing so. In which case, some mobile computers try to save power by using a light sensor to sense the level of ambient light and then selecting a display brightness based on the sensor's output. This is sometimes referred to as ambient light sense (ALS) technology.

A variety of factors can have an impact on ALS technology. For instance, different display technologies have different brightness characteristics. That is, some technologies are more efficient than others and can provide a brighter display at the same power level. Sensor placement can also be important because the same light sensor in the same ambient environment may provide very different readings depending on where the sensor is placed on a mobile computer. For instance, in lab experiments, readings varied from 170 lux to 300 lux when a sensor was moved from the top of a display panel down to the base. Different sensor designs may also provide very different readings depending on how much light reaches the sensor and the sensitivity of the sensor. For instance, in lab experiments, readings varied from 170 lux to 230 lux when a domed light diffuser was placed over a particular sensor. Due to these and other technical factors, an ALS technique that saves power and provides adequate display brightness for one combination of display and sensor, may not work well with another combination of display and sensor. In other words, most ALS techniques must be specially tuned for each combination of display panel, sensor, sensor placement, optics, etc. in order to provide a consistent user experience.

In addition to the various technical factors, there are subjective and physiological factors that can also have an impact on ALS technology. For instance, certain manufacturers or models of computer may emphasize a brighter display at the cost of battery life, while others may emphasize battery life over display brightness. And, the preferences of individual users may differ from the preferences of manufacturers. That is, a brightness level that a manufacturer deems adequate may not appear adequate in the opinion of every user.

Furthermore, user perception is more complicated than mere preference. Light sensors usually detect the rate of photons incident on a surface, measured in lux (lumens per square meter). The lux scale is linear, indicating a linear increase in brightness as the incidence of photons increases. Humans, however, do not perceive brightness linearly, nor do all humans perceive changes in brightness uniformly. Brightness perception can be very complex and person-specific. For example, comparing any two people, their pupils may dilate at different rates and to different extents, their optical receptors may adjust to light levels differently over time, and their brains may process optical information in different ways.

In a typical office environment, ambient light may measure in the 300 lux range. In this environment, some users may perceive a 20 or 30 lux fluctuation as a meaningful change in brightness, making a display harder or easier to see. Other users may be able to notice a meaningful change of just 10 lux. Outside, ambient daylight may fluctuate in the 10,000 to 30,000 lux range. A 20 or 30 lux fluctuation in this brighter environment would probably be imperceptible to virtually all users, and would have little or no effect on the readability of a display.

In other words, the amount of change in ambient light alone is not always a good indicator of a meaningful change in human perceived brightness. What might be a meaningful change at low light levels may not be a meaningful change at higher light levels, and what might be a meaningful change for one user may not be a meaningful change for another user. All these factors make it difficult to determine when to adjust display brightness.

### BRIEF DESCRIPTION OF DRAWINGS

Examples of the present invention are illustrated in the accompanying drawings. The accompanying drawings, however, do not limit the scope of the present invention. Similar references in the drawings indicate similar elements.

FIG. 1 illustrates one embodiment of a response model.

FIG. 2 illustrates one embodiment of a high-level process to define a response model.

FIG. 3 illustrates one embodiment of a process that could be used to define an initial response model.

FIG. 4 illustrates one embodiment of a process that could be used to modify a response model.

FIG. 5 illustrates one embodiment of a modified response model.

FIG. 6 illustrates one embodiment of an ambient light sense (ALS) capable notebook computer with hot keys for display brightness adjustment.

FIG. 7 illustrates one embodiment of a process that could be used to set limits in a response model.

FIG. 8 illustrates one embodiment of a graphical user interface (GUI) that could be used to adjust limits in a response model.

FIG. 9 illustrates one embodiment of a process that can use a response model to adjust display brightness.

FIG. 10 illustrates one embodiment of a process that can be used to recognize a meaningful change in ambient light levels.

FIG. 11 illustrates one embodiment of lux intervals comprising a human-perceived brightness scale.

FIG. 12 illustrates another embodiment of a process that can use a response model.

FIG. 13 illustrates one embodiment of a hardware system that can perform various functions of the present invention.

FIG. 14 illustrates one embodiment of a machine readable medium to store instructions that can implement various functions of the present invention.

### DETAILED DESCRIPTION OF THE INVENTION

In the following description, numerous specific details are set forth in order to provide a thorough understanding of the present invention. However, those skilled in the art will understand that the present invention may be practiced without these specific details, that the present invention is not limited to the depicted embodiments, and that the present invention may be practiced in a variety of alternative embodiments. In other instances, well known methods, procedures, components, and circuits have not been described in detail.

Parts of the description will be presented using terminology commonly employed by those skilled in the art to convey the substance of their work to others skilled in the art. Also, parts of the description will be presented in terms of operations performed through the execution of programming instructions. It is well understood by those skilled in the art that these operations often take the form of electrical, magnetic, or optical signals capable of being stored, transferred, combined, and otherwise manipulated through, for instance, electrical components.

Various operations will be described as multiple discrete steps performed in turn in a manner that is helpful for understanding the present invention. However, the order of description should not be construed as to imply that these operations are necessarily performed in the order they are presented, nor even order dependent. Lastly, repeated usage of the phrase “in one embodiment” does not necessarily refer to the same embodiment, although it may.

Certain embodiments of the present invention can provide generic or universal ambient light sense (ALS) techniques that can conveniently take into consideration a wide variety of technical, subjective, and physiological factors. That is, certain embodiments of the present invention can be universally applied to almost any display and sensor configuration, while also accommodating the subjective preferences and/or physiological peculiarities of multiple manufacturers and users. Many of these techniques are based on a response model that defines display brightness adjustments with respect to a reference display brightness for particular ambient light levels. Although the present invention is primarily described herein as a power saving feature for mobile computers, embodiments of the present invention can be used in virtually any device with a display, both mobile and stationary, battery powered or not.

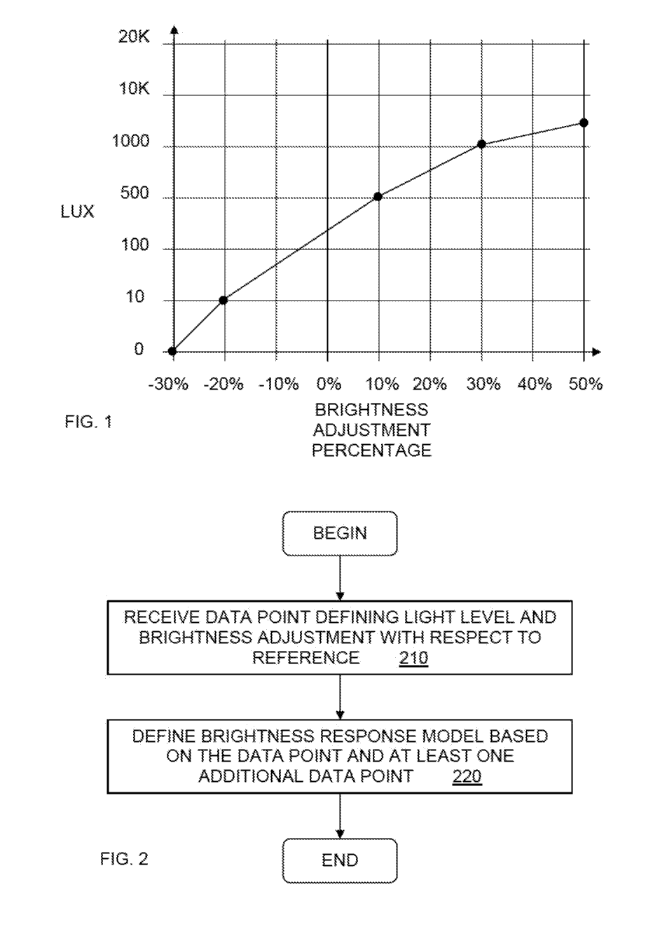

FIG. 1 illustrates one embodiment of an inventive response model. The vertical axis represents ambient light levels measured in lux. The horizontal axis represents display brightness adjustments as percentages of a reference display brightness. The curve defines particular brightness adjustments for particular ambient light levels. Alternate embodiments may use any number of different scales and units to represent ambient light levels and display brightness adjustments.

In the illustrated embodiment, if an ambient light sensor measures 500 lux, the corresponding brightness adjustment is 10%. That is, the response model indicates that the display brightness can be increased by 10% of the reference brightness level. If the ambient light measurement drops down to zero lux, the minimum limit on the display brightness adjustment is −30%. On the other end of the response curve, if the ambient light rises above about 1500 lux, the maximum limit on the display brightness adjustment is 50%.

The response model can be adapted to virtually any situation by defining or changing the reference brightness level, the shape of the response curve, and/or the limits of the response curve. For example, a manufacturer may want its notebook computers to have bright displays when plugged-in to a wall outlet, but the manufacturer may want to lower the display brightness to extend battery life when in a mobile mode of operation. In which case, the manufacturer may set the reference brightness level to the maximum brightness level when plugged-in, and may set the reference brightness level to 50% when unplugged.

The response model shown in FIG. 1 indicates 0% adjustment at about 300 lux. 300 lux could correspond to a typical ambient light environment for the device and the particular sensor configuration being used. If the reference brightness is set to the maximum brightness in the plugged-in mode of operation, the display would be at maximum brightness for any ambient light level at or above the typical environment. The response curve indicates higher adjustments beyond 300 lux, but the display cannot get any brighter in this example. At zero lux, the display can drop down to 70% of the maximum brightness. In addition to saving power, reducing the display brightness in a dark environment can improve the quality and readability of a display. That is, glare from a bright display in a dark room can cause eye strain, and darker colors on an excessively bright display may appear to wash out, with black becoming dark grey for instance.

When unplugged in this example, the display would be at 50% brightness in the typical environment at 300 lux. At or above about 1500 lux, the maximum brightness for the display would be about 75% of the maximum, or a 50% increase from the 50% reference brightness. At zero lux, the minimum brightness would be about 35%, or a 30% decrease from the 50% reference brightness.

A user, however, may work outdoors on a regular basis and may have a difficult time reading the display on sunlight days in the mobile mode of operation with the reference brightness set at 50%. This user may prefer a wider range of brightness adjustments in the mobile mode of operation, even if it means sacrificing battery life. For example, the user may increase the maximum adjustment from 50% up to 100%. In other words, by extending the curve in FIG. 1 out to this new maximum limit, the display brightness can be made to reach its maximum brightness (100% increase from the 50% reference brightness) even in the mobile mode of operation.

In the examples above, defining and changing the response model can be implemented in a variety of different ways. For instance, FIGS. 2 through 12 illustrate a number of embodiments of the present invention that can be used to define, change, and/or use ambient light response models. In various embodiments, the reference brightness can be changed, the response model itself can be changed, or both the reference brightness and the response model can be changed.

FIG. 2 illustrates one embodiment of the present invention at a high level. The illustrated process can form the basis of a variety of techniques for defining or changing a response model. At 210, the process receives a data point. This data point may define two pieces of information. First, it may define a particular ambient light level associated with a particular display. For example, the ambient light level may correspond to a light measurement from a particular configuration of light sensor and display device. Second, the data point may define a corresponding brightness adjustment for the display with respect to a reference display brightness.

Then, at 220, the process can define a brightness response model based on the data point and at least one additional data point. That is, in order to define the curve of a response model, two data points may be needed. For instance, a piece-wise linear approximation could be used to define the response model based on two or more data points. In other embodiments, any number of curve approximation techniques could be used.

The data point can be received in a number of different ways, some of which are described below with respect to other Figures. The additional data point(s) may already be available if the response curve was previously defined and the illustrated process is being used merely to change or update the existing response curve. If, however, the illustrated process was being used to define a new response curve, the additional data point(s) may also need to be received before the response curve can be defined.

In alternate embodiments, the data point may not explicitly define an ambient light level. Instead, the data point may define a maximum or minimum brightness adjustment limit for a response curve. In which case, the associated ambient light level could be derived from the intersection of the limit and the response curve.

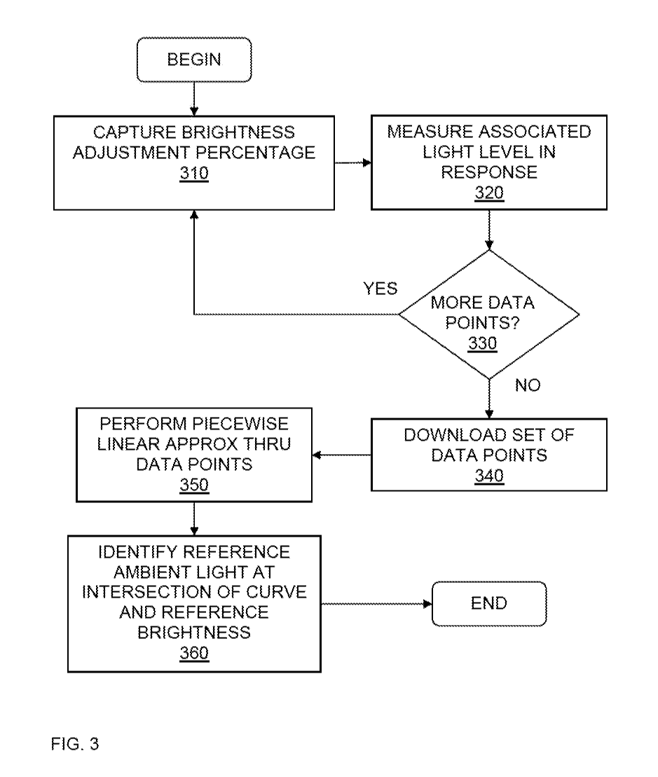

FIG. 3 illustrates one embodiment of a process to define a response model in more detail. The illustrated process uses the same basic technique described in FIG. 2, but may be particularly suited to a manufacturer defining a new response model. In 310 through 330, the process can collect data points for a response model, and, in 340 through 360, the process can use the data points to define the response model.

Specifically, at 310, the process can capture a brightness adjustment percentage with respect to a reference brightness level. For example, the reference brightness might be 50%, 90%, 100%, or some other level. Similarly, the brightness adjustment percentage might be −40% to +40%, −25% to +30%, or some other range of adjustments.

In response to capturing the brightness adjustment, the process can measure a light level associated with the brightness adjustment to form a data point at 340. These two functions can be done in a variety of different ways. For example, a manufacturer may use a particular device from a production line having a particular sensor and display configuration. In another example, a manufacturer may use a test fixture designed to model the characteristics of a device having a particular sensor and display configuration.

In any case, for a given ambient light environment and a given reference brightness level, an operator may simply adjust the display brightness up or down until the operator feels the display is adequately bright for the environment. Once the operator indicates an appropriate brightness has been set, the process can capture the brightness setting and measure the associated ambient light level. In other words, without any specific knowledge of the relative sensitivity of the particular light sensor being used, or the relative brightness of the display being used, an operator can quickly and easily define data points for the response curve based on the subjective priorities of the manufacturer using the process of FIG. 3. If the manufacturer wants to emphasize battery life, for instance, the operator can select dimmer settings. Conversely, if the manufacturer wants to emphasize display brightness, the operator can select brighter settings.

At 330, if there are more data points to collect, the process can return to 310. An operator could then change the ambient light level, adjust the display brightness, and indicate when the appropriate brightness has been set so that the process can capture another data point. This loop could be performed any number of times, and at various brightness levels and ambient light environments.

In alternate embodiments, the process could perform the same basic function in different ways. For example, the process itself could control the ambient light levels and prompt an operator to select an adequate brightness level for several different ambient environments.

In any case, at 340, once a set of data points have been captured, the process can download the set of data points to other devices having the same or similar sensor and display configuration. This could be done as part of the manufacturing process. Then, each device could use the set of data points to define its own response model at 350. This could be done, for instance, in a boot-up operation whenever a device is powered on. In the illustrated embodiment, the process uses a piece-wise linear approximation through the data points to define the response model. Other embodiments could use other curve approximations.

In alternate embodiments, the response model itself could be defined up-stream from the devices being manufactured. That is, rather than downloading just the set of captured data points, the entire response model could be defined and then downloaded.

The illustrated embodiment also shows at 360 that the process can identify the reference ambient light level at the intersection of the response curve and the reference brightness level. That is, the reference ambient light level is the light level at which the display brightness adjustment is zero. In many situations, the reference ambient light level is intended to be the default light level of the typical ambient environment for the device. Recognizing the reference ambient light level could be useful, as discussed below.

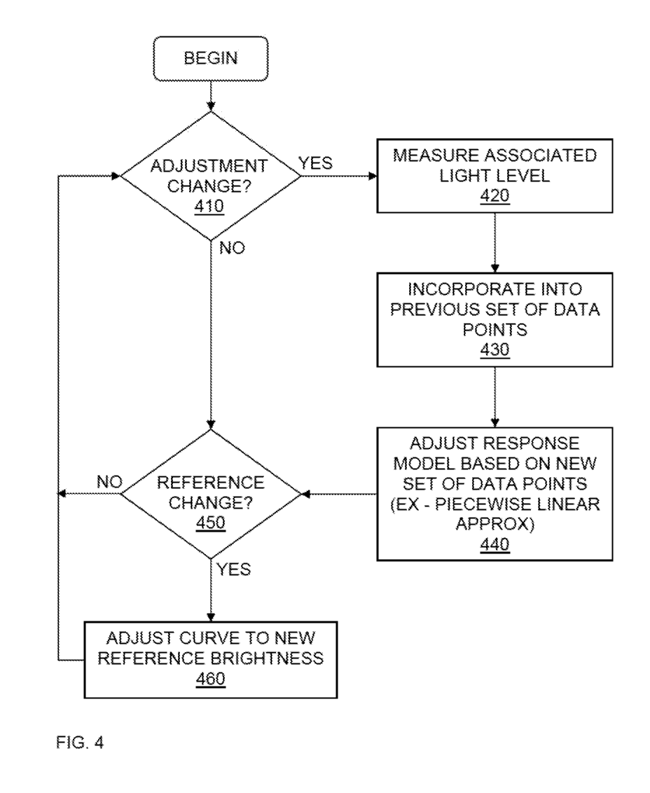

FIG. 4 illustrates another embodiment of a process to define a response model in more detail. The illustrated process also uses the same basic technique described in FIG. 2, but may be particularly suited for a user to conveniently and simply modify an existing response model based on individual preferences. For instance, the process of FIG. 4 could be used to update or change a response model that was originally defined using the process of FIG. 3.

At 410, if the process receives a brightness adjustment percentage from a user interface, the process can measure the associated ambient light level to create a new data point at 420. At 430 the new data point can be incorporated into a previously defined set of data points. For instance, if no data point exists in the previous data set for the current ambient light measurement, the new data point can be added to the data set. If, however, a data point already exists for the current ambient light measurement, the new data point can over-write the old data point.

At 440, the process can then adjust the response model based on the new set of data points. For example, this could involve repeating a piece-wise linear approximation through the entire new set of data points. In another example, this could involve recalculating just a portion of a response curve so that it extends through the new data point.

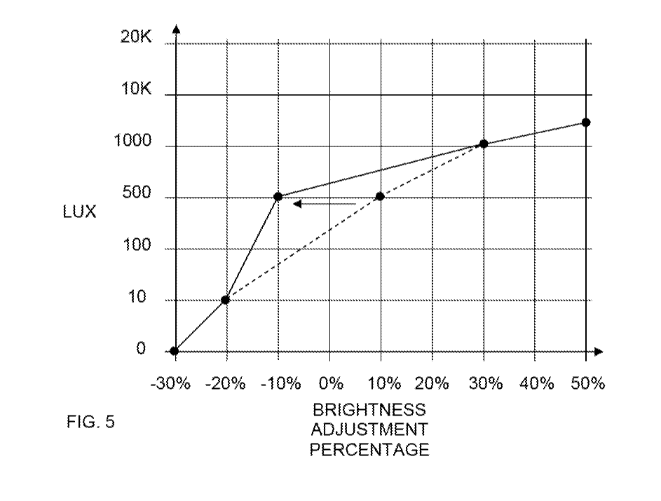

For example, referring back to the response curve in FIG. 1, if the current ambient level is 500 lux, the current brightness adjustment percentage would be 10%. If the display brightness level were reduced to −10% at the 500 lux level, the shape of the response curve could be shifted to that shown in FIG. 5. This has the effect of changing the reference ambient light level (where the corresponding brightness adjustment is 0%) from around 300 lux to around 700 lux.

Referring back FIG. 4, if the process does not receive a change to the reference brightness level at 410, or after adjusting a response model based on a new reference brightness level at 440, the process can proceed to 450. At 450, if the process receives a change to the reference display brightness level from a user interface, the process can adjust the response model to the new reference brightness level at 460. If no reference level adjustment is received in 450, or after the response model is adjusted in 460, the process can loop back to 410 to start over again.

Changing the reference brightness may not change the shape of the response curve, but can change the behavior of the entire response model. For instance, referring again to the response model of FIG. 1, if the reference brightness is changed from 50% to 90%, the minimum brightness of the display at zero lux will shift from 35% (−30% of 50%) to 63% (−30% of 90%). Conversely, the upper end of the response curve will effectively be cut-off. That is, the display will reach 100% brightness at just over 11% brightness adjustment.

In one embodiment, the process may be interrupt-driven. That is, the process may remain idle until a change is received from the user interface to initiate the process. In other embodiments, rather than allowing a user to change both the shape of the response curve and the reference brightness level of the response model, a user may be permitted to change only one. For instance, a process including just functions 410 through 440 may only allow a user to change the shape of the response curve. Similarly, a process including just functions 450 and 460 may only allow a user to change the reference brightness level of the response model.

In yet another embodiment, the same user input could be used to change either the shape or the reference level. For example, if the ambient environment is not at the reference ambient light level, a change in the brightness level could be used to change the shape of the response curve. If, however, the ambient environment is at the reference ambient light level, a change in the brightness level could be used to change the reference brightness level. This is where it may be useful to know the reference ambient light level. Functions 410 and 450 in the process of FIG. 4 could include determining if the ambient environment is at the reference ambient level and then, in response to a brightness adjustment, initiating either 420 to 440 to change the shape of the curve or 460 to change the reference level for the response model.

In some embodiments, the original set of data points may be saved as, for instance, a manufacturer's default setting. The new data set may also be saved as, for instance, a personal setting for a particular user's account. In which case, a notebook computer could revert back to the default model, as well as use different models for different user accounts.

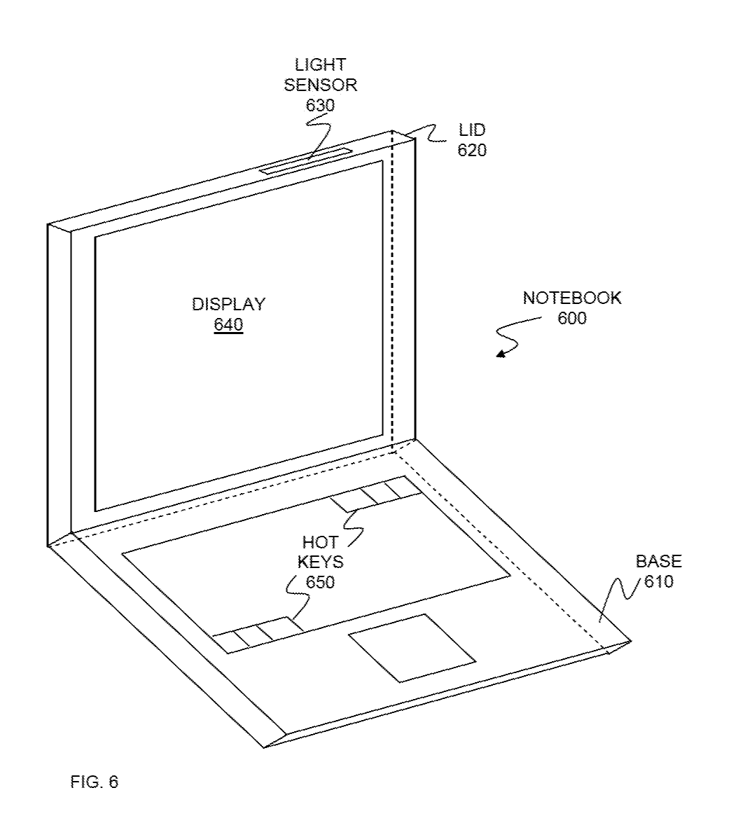

The process of FIG. 4 could be initiated in any of a number of ways. For example, FIG. 6 illustrates one embodiment of a notebook computer 600 that includes a display 640 and a light sensor 630 in lid 620, and a number of “hot keys” 650 in base 610. Hot keys are often included in notebook computers to provide a user interface to various hardware features, such as display brightness.

In one embodiment of the present invention, whenever a user manually adjusts display brightness using hot keys, the process of FIG. 4 could be initiated to update the response model. In other words, the user could change the shape of the response curve and/or the reference brightness level of the response model based on individual preference by simply changing the display brightness at a given ambient light level, and without any particular knowledge of the characteristics of the sensor or display. In another embodiment, a graphical user interface (GUI) could be used to change the brightness level and initiate the process of FIG. 4 in much the same way.

Hot keys and GUIs may allow a user to adjust the absolute brightness of a display, as opposed to the brightness adjustment percentage with respect to a reference brightness. In which case, it may be necessary to convert from an absolute brightness to a brightness adjustment percentage. That is, as used herein, the absolute brightness of a display refers to a percentage of the maximum possible brightness for the display, and the reference brightness refers to a particular absolute brightness level to which brightness adjustments can be applied. For example, when a user touches a brightness hot key, a scale may pop-up on the display showing the current absolute brightness level, often in the form of a bar graph or slider. The absolute brightness level may automatically move up or down the scale as the response model adjusts for changes in the ambient light. If the reference brightness is 60% and the brightness adjustment for the current ambient environment is +25%, the resulting absolute brightness shown on the scale would be 75%, or +25% of 60%. If a user were to manually increase the absolute brightness of the display to 85% for the same ambient environment using the hot keys, a conversion could be performed to determine the corresponding brightness adjustment percentage with respect to the reference brightness level. Then, the response model could be adjusted accordingly.

In FIG. 4, for instance, function 410 could calculate an adjustment percentage using an equation such as ((absolute brightness/reference brightness)−1)×100. If the reference brightness is set at 80% and the absolute brightness is set to 96%, the adjustment percentage would be ((96/80)−1)×100=20%. Similarly, if the reference brightness is 60% and the absolute brightness is 48%, the adjustment percentage would be ((48/60)−1)×100=−20%. Once the brightness adjust is determined, the process of FIG. 4 could go on to adjust the response model in Functions 420 to 460.

In alternate embodiments, a user may be able to directly change the brightness adjustment percentage, in which case a conversion may not be needed. For example, when a user touches a hot key, a scale may pop up showing the current brightness adjustment percentage, rather than the current absolute brightness.

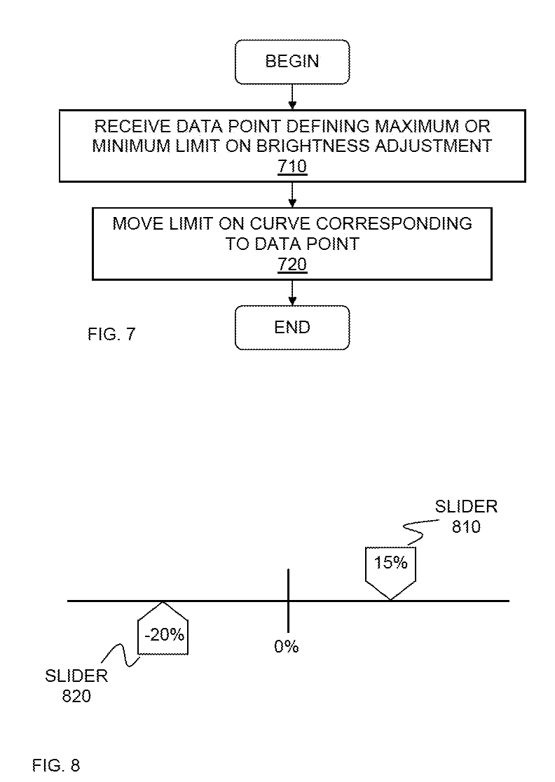

FIG. 7 illustrates yet another embodiment of a process to define a response model in more detail. The illustrated process uses the same basic technique described in FIG. 2, and may be particularly suited to define an aggressiveness for an ambient light sense (ALS) technique.

At 710, the process can receive a data point that defines a maximum or a minimum limit on brightness adjustments. Then, at 720, the process can move a limit along the response curve corresponding to the data point to constrain the operating range of the ALS technology. For example, referring again to the response model shown in FIG. 1, the response curve extends from −30% to 50%. But, using the process of FIG. 7, maximum and minimum limits can be defined at, for example, 10% and −10%. In which case, the ALS technique would only perform brightness adjustments between about 70 lux and 500 lux.

The limits could be received in any number of ways. For example, FIG. 8 illustrates one potential graphical user interface (GUI) that could be used. Slider 810 can correspond to a maximum limit and slider 820 can correspond to a minimum limit. Each time one of the sliders 810 or 820 is moved, the process of FIG. 7 could be initiated to receive a data point and move a response curve limit accordingly. In another example, a manufacturer could provide hot keys to adjust the limits in a similar fashion.

In one embodiment, slider 810 may only be adjustable on the right side of the scale and slider 820 may only be adjustable on the left side of the scale. In which case, to maximize power savings from ALS, slider 810 could be moved to 0% adjustment and slider 820 could be moved to the far left end of the scale. In this example, the maximum display brightness would be constrained to the reference brightness level and ALS adjustments would only reduce the brightness level in ambient environments below the reference ambient level. On the other hand, to maximize display brightness, slider 820 could be moved to 0% adjustment and slider 810 could be moved to the far right end of the scale. In this case, the minimum display brightness would be constrained to the reference brightness level and ALS adjustments would only increase the brightness level in ambient environments above the reference ambient level. In yet another example, ALS could essentially be turned off by moving both sliders to 0% adjustment.

In certain embodiments, the brightness limits could be permanently set by a manufacturing. For example, a manufacturer may set a maximum limit because a particular battery source is not able to support a brighter display setting. In which case, the manufacturer may limit the absolute brightness of the display rather than the relative brightness adjustment percentage. Alternatively, brightness limits could be adjusted by a user based on individual preference. Other embodiments could use both limits set and/or fixed by a manufacturer, as well as limits that can be adjusted by a user.

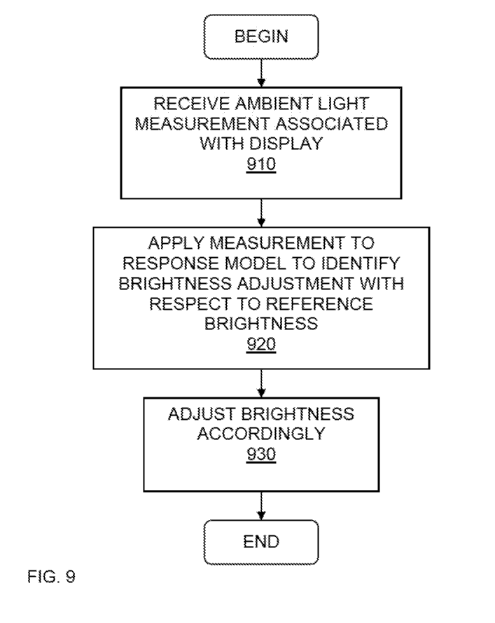

FIG. 9 illustrates one embodiment of a high-level process that can use an ambient light response model to adjust a display brightness level. At 910, the process can receive an ambient light measurement associated with a display. At 920, the process can apply the measurement to a response model to identify a brightness adjustment with respect to a reference brightness.

In one embodiment, applying the measurement to the response model could involve locating an intersection of the ambient light level with a response curve. In practice, the response curve may be stored in the form of a set of data points. If the data set does not contain a data point corresponding to the ambient light measurement, the process could find a data point in any of a number of ways. For example, the process could select a closest data point. As another example, the process could approximate the curve based on two or more neighboring data points, and then determine the intersection of the ambient light level with the approximation. In any case, at 930, the process can adjust the brightness accordingly.

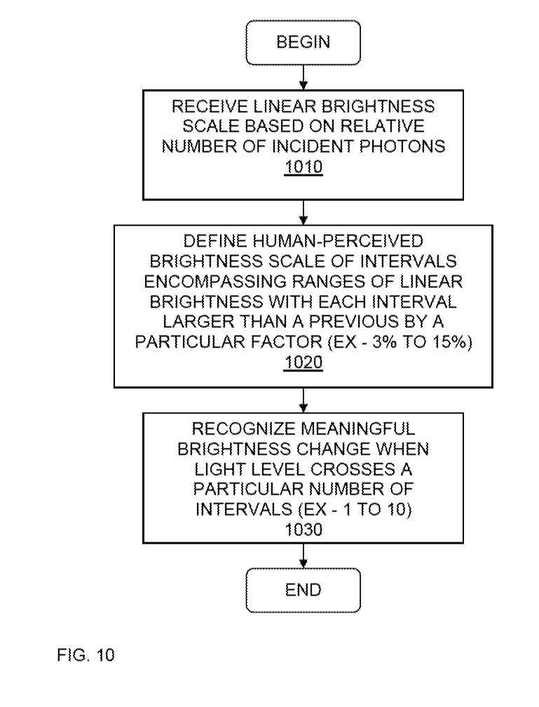

The ambient light measurement can be received in a number of different ways. FIG. 10 illustrates one embodiment of a process that can recognize a meaningful change in ambient light for which the process of FIG. 9 can be initiated. As discussed in the Background, the human eye does not perceive brightness linearly because pupils can dilate, optical receptors can adjust to light levels over time, and brains can process images differently. What might be a meaningful change in lux at low light levels may not be a meaningful change at higher light levels. In order to address this, the process of FIG. 10 can define a human-perceived brightness scale.

Specifically, at 1010, the process can receive a linear brightness scale, such as the lux scale, which is based on the relative number of photons incident on a surface. Then, at 1020, the process can define a human-perceived brightness scale in intervals that encompass ranges of the linear brightness scale. Each interval further up the scale can encompass a larger range of the linear scale by a particular factor. Typical factors could be, for example, 3% to 15%. The factor does not need to be the same for all of the intervals. For example, if an interval encompasses 100 lux to 150 lux, the next larger interval may encompass 151 lux to 208.5 lux, using a factor of 15%. Similarly, if an interval encompasses 1000 lux to 5000 lux, the next larger interval may encompass 5001 lux to 9,401 lux, using a factor of 10%.

The size of the first interval and the values of the factor(s) can be selected in any number of ways. Smaller factors will produce more intervals and greater sensitivity to changes in brightness. Larger factors will produce less intervals and less sensitivity to brightness.

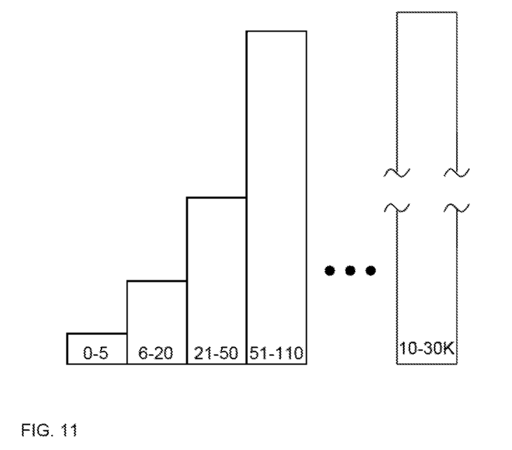

Skipping briefly to FIG. 11, FIG. 11 graphically represents one possible embodiment of human-perceived brightness intervals. The sizes of the intervals are exaggerated compared to typical intervals for purposes of illustration. The first interval encompasses 0 to 5 lux. The second interval encompasses 6 to 20 lux, increasing by a factor of about 3. The third interval encompasses 21 to 50 lux, increasing by a factor of 2. The fourth interval encompasses 51 to 110 lux, again increasing by a factor of 2. The intervals can continue to get larger. In the illustrated embodiment, the last interval encompasses 10K to 30K lux.

Referring back to FIG. 10, once the human-perceived brightness scale is defined, the process can recognize a meaningful change when the ambient light level crosses a particular number of intervals at 1030. For example, one embodiment may recognize a meaningful change in brightness every time a boundary between two intervals is crossed.

Even when ambient light appears constant however, it actually tends to fluctuate rapidly around some average value. If the ambient light level is hovering in the region of a boundary, these rapid fluctuations may trigger more “meaningful” changes than is desired. One way to reduce this effect in other embodiments is to recognize meaningful changes when two or more intervals are crossed. The number of crossing to be used can be selected in any number of ways depending of various factors, such as the number and size of intervals in the human-perceived brightness scale and the desired sensitivity of the recognition process.

Another way to think about the human-perceived brightness scale is to recognize a meaningful change in ambient light whenever the linear light level changes by a certain factor from the last meaningful change in ambient light. For example, if the ambient light level that triggered the last meaningful change was 500 lux, the next meaningful change may be recognized if the lux measurement increases or decreases by 6%, 9%, 12%, or any other factor. Again, the size of the factor determines how sensitive the process is to ambient light changes.

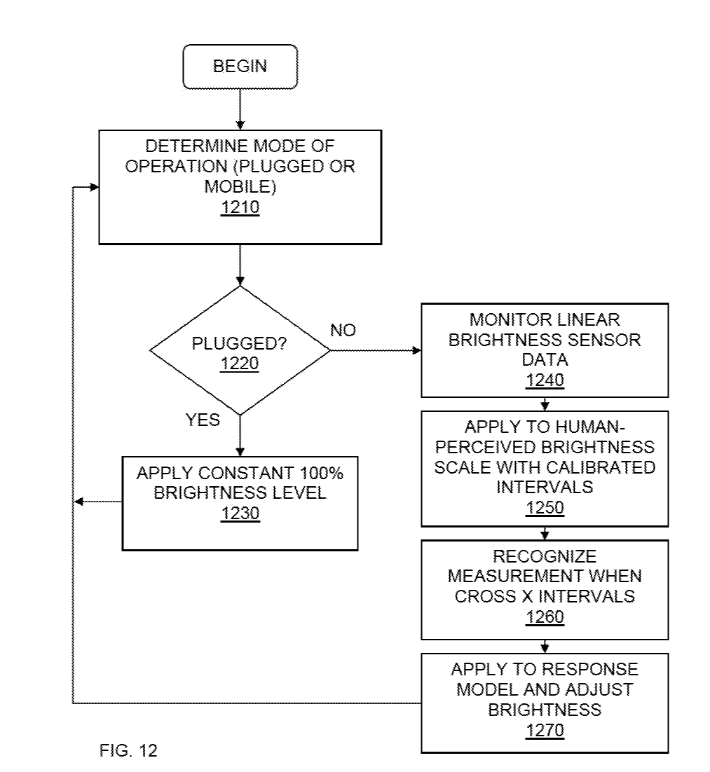

FIG. 12 illustrates one example of how a number of the processes and features described above can be used together. At 1210, the process can determine a mode of operation for a device that has ambient light sense (ALS) capabilities. For example, a notebook computer may have a mobile mode of operation and a plugged mode of operation. Any number of techniques can be used to recognize the device's current mode of operation.

At 1220, if the device is in a plugged mode, the process can apply a constant 100% brightness level at 1230. That is, when the device is plugged-in, power may be plentiful and ALS may be unnecessary. The process can continue to provide the maximum brightness level until the mode of operation changes.

At 1220, if the device enters a mobile mode of operation, the process can begin monitoring a stream of linear brightness sensor data, such as lux values, at 1240. At 1250, the process can apply the sensor data to a human-perceived brightness scale with intervals calibrated to provide a certain level of sensitivity. At 1260, the process can recognize a meaningful change when the sensor data crosses a certain number of intervals. Or, another way to think about it is, a meaningful change can be recognized when the sensor data changes by a certain factor with respect to an earlier lux value or an initial lux value. For example, the initial lux value could be set to the reference ambient light level as defined by the response model.

Once a meaningful change is recognized at 1260, the process can apply the measured ambient light level to the response model and adjust the brightness percentage accordingly at 1270. The process can continue to monitor the sensor data, recognize meaningful changes, and adjust the brightness percentage until the mode changes again.

FIGS. 1-12 illustrate a number of implementation specific details. Other embodiments may not include all the illustrated elements, may arrange the elements differently, may combine one or more of the elements, may include additional elements, and the like.

Other embodiments of the response model could utilize forms of input in addition to ambient light measurements. That is, a user or manufacturer may want different brightness responses for different environments or different situations. Any number of environmental or situational variables could be used to define multi-dimensional response models for adjusting display brightness. Virtually any condition that a device can detect, or be made aware of, can be used to define a display response model to affect readability, image quality, power consumption, etc.

For instance, a response model may be defined to automatically use a higher reference brightness when an email application is active and a lower reference brightness when a DVD is playing. Similarly, a response model could be defined to automatically use entirely different response curves for different applications. As another example, a mobile computer may use multiple response curves and/or reference brightnesses depending on the battery level, increasing the emphasis on power savings as battery life dwindles.

The embodiments described above are primarily directed to saving power using transmissive display technology. A transmissive display is essentially made up of an array of tiny “shutters” in front of a full-spectrum backlight. Each pixel on a display screen is made up of several shutters, usually one shutter for passing red light, one shutter for passing green light, and one shutter for passing blue light. The color and brightness of each pixel is determined by opening or closing the shutters in varying degrees to mix different intensities of red, blue, and green light. Embodiments of the present invention can save power in transmissive displays by reducing the brightness of the backlight under various conditions.

In addition to saving power, however, embodiments of the present invention can also be used to improve readability and image quality. For instance, when a mobile computer is plugged in, saving power may not be a major concern. But, as mentioned above, embodiments of the present invention may still dim the backlight in a dark environment to cut down on glare and prevent dark colors from being washed-out.

In a similar fashion, embodiments of the present invention can be used to save power and/or improve readability and image quality using other types of display technology. For instance, each pixel of a transreflective display includes both “shutters” to selectively pass light from a backlight as well as “reflectors” to selectively reflect ambient light. One embodiment of a response model for a transreflective display may not use the backlight at all (−100% adjustment) in a an ambient environment where the reflectors are able to reflect enough light to form a clear image. In a very bright ambient environment however, the ambient light may saturate the reflectors, causing the image to wash out. In which case, a response model may apply a large positive brightness adjustment to the backlight to improve the image. On the other hand, in a dark ambient environment, there may not be enough ambient light for the reflectors to form a good image. In which case, a response model may apply a brightness adjustment to the backlight to improve the image, but the adjustment level may be lower in the dark environment than in the bright environment. In other words, one embodiment of a response model for a transreflective display may be roughly U-shaped, with a low point between higher points at either end of the curve, possibly with higher adjustments for brighter environments and smaller lower adjustments for darker environments. Other response model shapes are possible depending a variety of factors, such as the display technology, the efficiency of a particular display, subjective preference, etc.

Organic light emitting diode (OLED) technology is another type of display technology to which embodiments of the present invention can be applied. An OLED display does not need a backlight. Instead, an OLED display is made of thin layers of organic material that emit light when voltages are applied. The intensity of the emitted light is related to the magnitude of the applied voltage. Each pixel may include a separate voltage for red, green, and blue emitting materials. In which case, embodiments of the present invention can apply brightness adjustments to these voltages to save power and/or improve image quality much like other embodiments of the present invention can apply brightness adjustments to backlight voltages. For example, one embodiment of the present invention could apply a negative adjustment percentage to the voltages when in a dark environment and a positive adjustment percentage when in a bright environment.

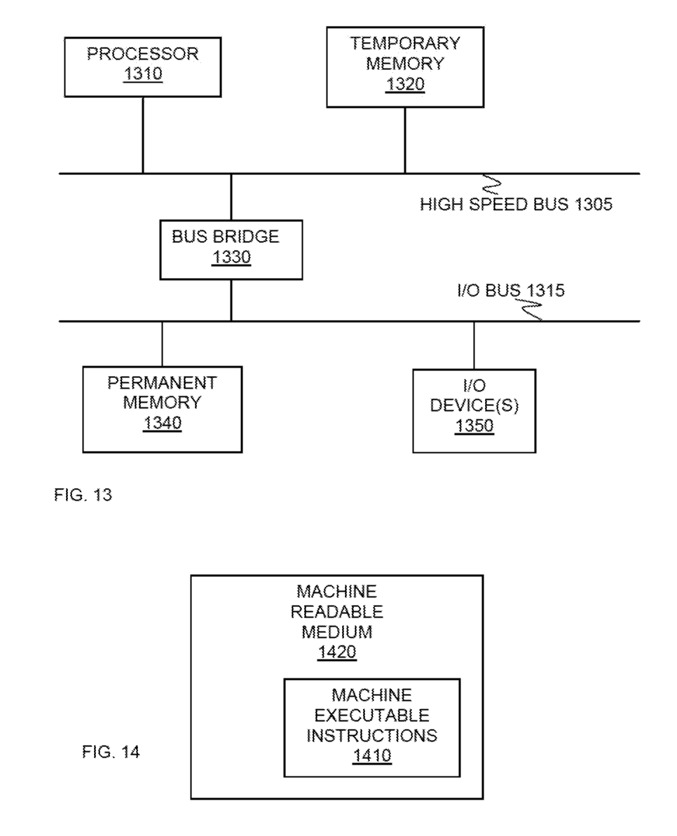

FIG. 13 illustrates one embodiment of a generic hardware system intended to represent a broad category of systems. In the illustrated embodiment, the hardware system includes processor 1310 coupled to high speed bus 1305, which is coupled to input/output (I/O) bus 1315 through bus bridge 1330. Temporary memory 1320 is coupled to bus 1305. Permanent memory 1340 is coupled to bus 1315. I/O device(s) 1350 is also coupled to bus 1315. I/O device(s) 1350 may include a display device, a keyboard, one or more external network interfaces, etc.

Certain embodiments may include additional components, may not require all of the above components, or may combine one or more components. For instance, temporary memory 1320 may be on-chip with processor 1310. Alternately, permanent memory 1340 may be eliminated and temporary memory 1320 may be replaced with an electrically erasable programmable read only memory (EEPROM), wherein software routines can be executed in place from the EEPROM. Some implementations may employ a single bus, to which all of the components are coupled, while other implementations may include one or more additional buses and bus bridges to which various additional components can be coupled. Similarly, a variety of alternate internal networks could be used including, for instance, an internal network based on a high speed system bus with a memory controller hub and an I/O controller hub. Additional components may include additional processors, a CD ROM drive, additional memories, and other peripheral components known in the art.

Various functions of the present invention, as described above, can be implemented using one or more hardware systems such as the hardware system of FIG. 13. In one embodiment, the functions may be implemented as instructions or routines that can be executed by one or more execution units, such as processor 1310, within the hardware system(s). As shown in FIG. 14, these machine executable instructions 1410 can be stored using any machine readable storage medium 1420, including internal memory, such as memories 1320 and 1340 in FIG. 13, as well as various external or remote memories, such as a hard drive, diskette, CD-ROM, magnetic tape, digital video or versatile disk (DVD), laser disk, Flash memory, a server on a network, etc. In one implementation, these software routines can be written in the C programming language. It is to be appreciated, however, that these routines may be implemented in any of a wide variety of programming languages.

In alternate embodiments, various functions of the present invention may be implemented in discrete hardware or firmware. For example, one or more application specific integrated circuits (ASICs) could be programmed with one or more of the above described functions. In another example, one or more functions of the present invention could be implemented in one or more ASICs on additional circuit boards and the circuit boards could be inserted into the computer(s) described above. In another example, one or more programmable gate arrays (PGAs) could be used to implement one or more functions of the present invention. In yet another example, a combination of hardware and software could be used to implement one or more functions of the present invention.

Thus, techniques for adjusting the brightness of a display are described. Whereas many alterations and modifications of the present invention will be comprehended by a person skilled in the art after having read the foregoing description, it is to be understood that the particular embodiments shown and described by way of illustration are in no way intended to be considered limiting. Therefore, references to details of particular embodiments are not intended to limit the scope of the claims.

What is claimed is:

1. A method, comprising:
receiving from at least one ambient light sensor a first measurement of an amount of ambient light in an environment;
receiving, from a user interface, a reference brightness level of a display device, the reference brightness level being associated with the first measurement amount of ambient light;
receiving from the at least one ambient light sensor a second measurement of an amount of ambient light in the environment, wherein the second measurement is not equal to the first measurement; and
automatically adjusting a current brightness level of the display device in response to the second measurement being not equal to the first measurement.

2. The method of claim 1, further comprising:
receiving, from the user interface, a disable command; the disable command to disable further automatic adjusting of the current brightness level of the display device.

3. The method of claim 2, wherein when the disable command is received, returning the display device brightness level to the received reference brightness level.

4. A non-transitory machine-readable medium having stored thereon instructions, which if executed by a machine causes the machine to perform a method comprising:
receiving from at least one ambient light sensor a first measurement of an amount of ambient light in an environment;
receiving, from a user interface, a reference brightness level of a display device, the reference brightness level being associated with the first measurement amount of ambient light;
receiving from the at least one ambient light sensor a second measurement of an amount of ambient light in the environment, wherein the second measurement is not equal to the first measurement; and
automatically adjusting a current brightness level of the display device in response to the second measurement being not equal to the first measurement.

5. The machine-readable medium of claim 4, wherein the performed method further comprises:
receiving, from the user interface, a disable command, the disable command to disable further automatic adjusting of the current brightness level of the display device.

6. The machine-readable medium of claim 5, wherein the performed method further comprises:
when the disable command is received, returning the display device brightness level to the received reference brightness level.

7. A device, comprising:
a display;
a processor;
a user interface;
at least one ambient light sensor; and
logic to:
receive from the at least one ambient light sensor a first measurement of an amount of ambient light in an environment;
receive, from the user interface, a reference brightness level of the display, the reference brightness level being associated with the first measurement amount of ambient light;
receive from the at least one ambient light sensor a second measurement of an amount of ambient light in the environment, wherein the second measurement is not equal to the first measurement; and
automatically adjust a current brightness level of the display in response to the second measurement being not equal to the first measurement.

8. The device of claim 7, wherein the logic is further operable to:
receive, from the user interface, a disable command, the disable command to disable further automatic adjusting of the current brightness level of the display.

9. The device of claim 8, wherein the logic is further operable to:
when the disable command is received, return the display brightness level to the received reference brightness level.
